(19) United States
(12) Patent Application Publication
(10) Pub. No.: US 2014/0130687 A1
(43) Pub. Date: May 15, 2014

(54) PRIMER COMPOSITION, STRUCTURE INCLUDING PRIMER LAYER COMPOSED OF THE COMPOSITION, AND METHOD OF PRODUCING THE STRUCTURE

(71) Applicants: Kunihiko Shibusawa, Takasaki-shi (JP); Takeshi Sato, Takasaki-shi (JP)

(72) Inventors: Kunihiko Shibusawa, Takasaki-shi (JP); Takeshi Sato, Takasaki-shi (JP)

(73) Assignee: Taiyo Chemical Industry Co., Ltd., Takasaki-shi, Gunma (JP)

(21) Appl. No.: 14/129,846

(22) PCT Filed: Jul. 2, 2012
(86) PCT No.: PCT/JP2012/066925

§ 371 Date: Jan. 22, 2014

(30) Foreign Application Priority Data
Jul. 1, 2011 (JP) 2011-147669

(51) Int. Cl. C09D 5/00; B41F 15/36

(52) U.S. Cl. CPC C09D 5/002; B41F 15/36
USPC 101/127; 524/588; 442/1; 428/304.4

(57) ABSTRACT

[Object] One object is to provide a primer composition composed of an amorphous carbon material and used for forming a primer layer that tightly binds with fluorine-containing silane coupling agent. A primer composition according to an embodiment of the present disclosure is composed of an amorphous carbon material containing at least one element of silicon, oxygen, and nitrogen.

### CROSS-REFERENCE TO RELATED APPLICATIONS

This application is based on and claims the benefit of priority from Japanese Patent Application Serial No. 2011-147669 (filed on Jul. 1, 2011), the contents of which are hereby incorporated by reference in their entirety.

### TECHNICAL FIELD

The present disclosure relates to a primer composition, and in particular, to a primer composition used as a primer layer for fluorine-containing silane coupling agent. Additionally, the present disclosure relates to a structure including a primer layer composed of the primer composition, and a method of producing the structure.

### BACKGROUND

There are known surface modification processes in which coating is applied to a surface of a substrate with silane coupling agent containing fluorine to provide the surface of the substrate with oil repellence. For example, a fluorine coating layer composed of fluorine-containing silane coupling agent is formed on a surface of a screen printing mesh to provide the mesh with oil repellence and enhance demoldability of printing paste. In many cases, fluorine-containing silane coupling agent is not applied directly on a mesh body composed of a metal such as stainless steel but applied on a primer layer as an intermediate, so as to ensure the fixity of the agent on the mesh. For example, there are known methods in which a mesh is coated with a liquid primer and then fluorine-containing silane coupling agent is applied onto the liquid primer (See, Japanese Patent Application Publication Nos. 2006-347062 and 2009-45867).

Additionally, there are known techniques for electronic component conveyors, wherein a porous sheet provided on an adsorbing port of an adsorbing collet is coated with fluorine-containing silane coupling agent so as to prevent electronic components being conveyed from being adhered to the porous sheet. Such a porous sheet is coated with fluorine-containing silane coupling agent via a liquid agent.

### RELEVANT REFERENCES

### List of Relevant Patent Literature

Patent Literature 1: Japanese Patent Application Publication No. 2006-347062
Patent Literature 2: Japanese Patent Application Publication No. 2009-45867

### SUMMARY

Unfortunately, a liquid primer tends to spread into an opening in a work such as a mesh and a porous sheet and block the opening. Particularly, a liquid primer used on a screen printing mesh may block printing pattern openings and prevent accurate application of printing paste in accordance with the printing pattern.

One way to overcome this problem is to form, on the mesh surface, an amorphous carbon film as a primer layer through a dry process such as CVD method in place of a liquid primer, the amorphous carbon film being composed of an amorphous carbon material such as diamond-like carbon (DLC), and form a fluorine coating layer on the DLC film. However, a fluorine coating layer does not have sufficient fixity on the amorphous carbon film.

To overcome the above problem, various embodiments of the present disclosure provide a primer composition composed of an amorphous carbon material and used for forming a primer layer that tightly binds with fluorine-containing silane coupling agent. Additionally, the various embodiments of the present disclosure provide a structure including a primer layer composed of the primer composition, and a method of producing the structure.

The inventors have found that an amorphous carbon film composed of at least one element selected from the group consisting of silicon (Si), oxygen (O), and nitrogen (N) has excellent fixity to fluorine-containing silane coupling agent.

A primer composition according to an embodiment of the present disclosure may be composed of an amorphous carbon material containing at least one element of silicon, oxygen, and nitrogen.

A structure according to an embodiment of the present disclosure may comprise a substrate and an amorphous carbon film layer formed directly or indirectly on the substrate and containing at least one element of silicon, oxygen, and nitrogen. As described above, in an embodiment of the present disclosure, an amorphous carbon film layer may be formed either directly on the substrate or indirectly on the substrate with an intermediate layer positioned therebetween.

A method of producing a structure according to an embodiment of the present disclosure may comprise the steps of preparing a substrate and forming on the substrate an amorphous carbon film layer containing at least one element of silicon, oxygen, and nitrogen.

### ADVANTAGES

Various embodiments of the present disclosure provide a primer composition composed of an amorphous carbon material and used for forming a primer layer that tightly binds with fluorine-containing silane coupling agent. Additionally, the various embodiments of the present disclosure provide a structure including a primer layer composed of the primer composition, and a method of producing the structure.

### BRIEF DESCRIPTION OF THE DRAWINGS

FIG. 1 is a schematic plan view illustrating the general configuration of a screen printing plate including a mesh according to an embodiment of the present disclosure.

FIG. 2 is a schematic cross-sectional view illustrating the screen printing plate including a mesh according to an embodiment of the present disclosure.

FIG. 3 is a schematic view illustrating a part of an electronic component conveyor having a porous sheet according to an embodiment of the present disclosure.

FIG. 4 is a graph illustrating results of measurement of contact angles with mineral spirit in Examples 1 to 7 and Comparative Example 1.

FIG. 5 is a graph illustrating results of measurement of contact angles with water in Examples 1 to 9 and Comparative Example 1.

FIG. 6 is a graph illustrating results of measurement of contact angles with mineral spirit at multiple points on a surface of a sample for Comparative Example 1.

FIG. 7 is a graph illustrating results of measurement of contact angles with mineral spirit at multiple points on a surface of a sample for Example 7.

FIG. 8 is a photograph of the sample surface of Comparative Example 2.

FIG. 9 is a photograph of the sample surface of Comparative Example 3.

FIG. 10 is a photograph of the sample surface of Example 10.

FIG. 11 shows photographs of the sample surfaces of Comparative Example 4 and Example 12 taken before and after elongation.

### DESCRIPTION OF EXAMPLE EMBODIMENTS

Various embodiments of the present disclosure will now be described with reference to the attached drawings. In each of the embodiments, the same components are denoted by the same reference signs for explanation, and the detailed description of the same components is appropriately omitted.

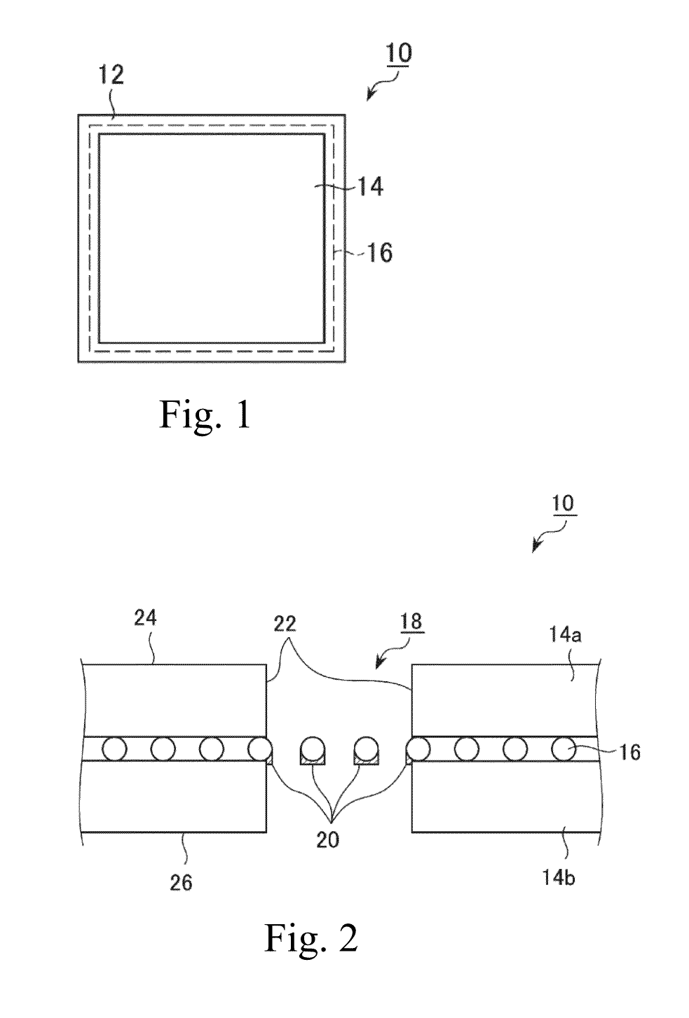

A primer composition according to an embodiment of the present disclosure may be composed of an amorphous carbon material containing at least one element of silicon, oxygen, and nitrogen. The primer composition may be used in the form of a primer layer in various structures. For example, the primer composition according to an embodiment of the present disclosure may be used in the form of a primer layer when a fluorine-containing silane coupling agent is applied on a screen printing mesh. FIG. 1 is a schematic plan view illustrating the general configuration of a screen printing plate, and FIG. 2 is a schematic cross-sectional view illustrating the screen printing plate according to an embodiment of the present disclosure. On the screen printing plate is formed a primer layer composed of a primer composition according to an embodiment of the present disclosure. FIGS. 1 and 2 each schematically illustrate the configuration of the screen printing plate according to an embodiment of the present disclosure, and it should be noted that dimensional relationship may not be not accurately reflected in the drawings.

As shown, the screen printing plate 10 may comprise a frame 12 and a mesh 16 attached to the frame 12. The frame 12 may be composed of cast iron, stainless steel, or aluminum alloy. The mesh 16 may be composed of a resin such as polyester or stainless steel (SUS304). The mesh 16 may be entirely or partially coated with an emulsion 14.

The mesh 16 according to an embodiment of the present disclosure may be fabricated by weaving threads of various materials and diameters. The surface roughness, sectional shape, and weaving method of the threads constituting the mesh 16 may be appropriately varied in accordance with the applications. The sectional shapes may include, for example, circular, oval, rectangular, polygonal, irregular, and star shapes. Examples of weaving method may include plain weave, twill weave, and three-dimensional weave. The material of the threads constituting the mesh 16 may be, for example, a metal such as stainless steel, steel, copper, titanium, or tungsten or an alloy thereof. The material of the threads constituting the mesh 16 may also be a chemical fiber such as polypropylene, polyester, polyethylene, nylon, or vinyl, a mixed fiber such as rayon, a carbon fiber, an inorganic material such as glass fiber, or a natural fiber such as wool, silk, cotton, or cellulose. For example, the mesh 16 may be fabricated by weaving stainless steel fibers having a diameter φ of 15 μm with a mesh opening width of 24.7 μm to a mesh count of 640 (that is, 640 mesh fibers per one inch width).

The mesh 16 may be fixed at the portions where fibers cross each other (intersections) with a plating extract, adhesive, vapor-deposited film, or sputtered film. The plating extract may be applied by, for example, electrolytic nickel plating method. In an embodiment, the intersections between the threads of the mesh may be compressed to reduce the thickness of the mesh 16 to the thickness of one thread of the mesh. The specifications of the mesh 16 are not limited to those described herein such as the thickness, mesh count, uniformity of the size of mesh openings, positions of mesh openings, taper angle of mesh openings, and shape of the openings; these specifications may be varied in accordance with printing method, printing pattern, printing medium, and required endurance. Further, the edges of the openings of the mesh 16 may be appropriately chamfered.

The mesh 16 may be a combination of a plurality of meshes. For example, meshes of the same type or different types may be combined together.

As described above, the mesh 16 are ordinarily fabricated by weaving thread-like material but may also be fabricated by other methods. For example, the mesh 16 may be fabricated by electrotyping, printing, and photolithography. Also, the mesh 16 may be fabricated by forming through-halls in a substrate by various methods such as laser processing, etching, drilling, punching, and electric discharging. The through-halls formed in these processes may correspond to the openings of the mesh 16. The above materials and fabrication methods may be appropriately combined.

In an embodiment, a diazo-based photosensitive emulsion can be used as the emulsion 14, for example. A print pattern opening 18 may be formed in the emulsion 14 by, for example, photolithography so as to correspond to a print pattern. The print pattern opening 18 may be formed so as to penetrate the emulsion 14 in the thickness direction. In a photolithographic process, the emulsion 14 applied to the mesh 16 may be exposed to light with a photomask pattern to cure part of the emulsion 14, and then the other region of the emulsion 14 than the part cured by the exposure to light may be removed to leave only the cured part on the mesh 16, so that the print pattern opening 18 is formed. The print pattern opening 18 may be defined by inner walls 22 of the emulsion 14. Furthermore, in place of directly attaching the mesh 16 provided with a print pattern to the frame 12, a support screen (not illustrated) separate from the mesh 16 may be attached to the frame 12, and then the mesh 16 may be attached to the support screen. In an embodiment, part of the support screen which overlaps the mesh 16 may be removed with a cutter knife. The printing pattern openings 18 may be formed by methods other than photolithography. For example, in the case where reproducibility of a printing pattern is not strictly required, any material that can form printing pattern openings on the screen mesh, such as clay and plaster, can be used.

In other embodiments, the emulsion 14 may be replaced with a printing pattern retainer shaped in a plate or foil and provided with printing pattern openings 18. The printing pattern retainer may be formed of various materials such as metals, alloys, or resins. Examples of the metals that can be used as a material of the printing pattern retainer include iron steel, copper, nickel, gold, silver, zinc, aluminum, and titanium. Examples of the alloys that can be used as a material of the printing pattern retainer include aluminum alloy, titanium alloy, stainless steel alloy, binary alloy such as chrome molybdenum steel alloy, Ni—Co alloy, or Ni—W alloy, and multi-component alloy. Examples of resins that can be used as a material of the printing pattern retainer include polypropylene, polyester, polyethylene, nylon, acrylic, PET, PEN, polyimide, polyimide-amide, glass epoxy, and FRP. In addition, materials usable for printing pattern retainer include cellulose, glass, ceramic, synthetic rubber such as nitrile, and natural rubber. These materials may be combined with other materials, if necessary. The printing pattern retainer formed of these materials and shaped in a plate or foil may be affixed on the mesh 16. The printing pattern in the printing pattern retainer may be formed either before or after affixture on the mesh 16.

In an embodiment, the surface of the threads of the mesh 16 may have formed thereon an amorphous carbon layer composed of an amorphous carbon material according to an embodiment of the present disclosure. The amorphous carbon film is so thin that it is omitted from the drawings. The amorphous carbon material according to an embodiment of the present disclosure may be composed mainly of, for example, carbon (C), hydrogen (H), and silicon (Si). Accordingly, the amorphous carbon film composed of the amorphous carbon material may be an a-C:H:Si film composed mainly of C, H, and Si. The Si content in the amorphous carbon material is, for example, in the range of 0.1 to 50 at %, and preferably 10 to 40 at %. The amorphous carbon film according to an embodiment of the present disclosure can be formed by, for example, a plasma chemical vapor deposition (CVD) method. Examples of reaction gas used as a silicon source include tetramethylsilane, methylsilane, dimethylsilane, trimethylsilane, dimethoxydimethylsilane, and tetramethylcyclotetrasiloxane. Since the amorphous carbon film formed on the mesh 16 exhibits high affinity to adhesives, the mesh 16 having formed thereon the amorphous carbon film can be steadily fixed to the frame 12 with an adhesive or an adhesive tape. In addition, the amorphous carbon film according to an embodiment of the present disclosure is in general highly adhesive to the emulsion 14, and the emulsion 14 can be therefore steadily retained by the mesh 16.

Further, when a high energy light such as ultra-violet rays is applied to the portions where to form printing pattern openings 18 in the photosensitive emulsion 14 applied on the mesh 16 thereby to form the printing pattern openings 18, the applied light may cause oxidization (surface activation) of the amorphous carbon film formed on the surface of the mesh 16. Thus, the silane coupling agent may be tightly affixed on the surface of the mesh 16. In an embodiment, after the printing pattern openings 18 are formed in the emulsion 14 applied on the mesh 16, the amorphous carbon film of the present disclosure may be formed on the mesh 16 exposed from the printing pattern openings 18. The mesh 16 may also be used for solid printing. When the mesh 16 is used for solid printing, the emulsion 14 may not be required.

In an embodiment of the present disclosure, the amorphous carbon film formed on the mesh 16 may include a polymeric carbon film that does not exhibit peaks in D band (near 1,350 cm⁻¹) or G band (1,500 cm⁻¹) through Raman spectroscopy.

Various elements can be incorporated into the amorphous carbon material according to an embodiment of the present disclosure in addition to or in place of Si, so as to enable a below-described silane coupling agent to be retained with high fixity. For example, the amorphous carbon material may contain C, H, and Si, and additionally, oxygen atoms (O). The O content in the amorphous carbon material can be changed by adjusting the proportion of oxygen flow in the total flow of Si-containing main source gas and oxygen. The proportion of an oxygen flow in the total flow of main source gas and oxygen may be adjusted, for example, in the range of 0.01 to 12%, preferably 0.5 to 10%. Further, the amorphous carbon material according to an embodiment of the present disclosure may contain C, H, Si, and O, and additionally, nitrogen (N). Further, the amorphous carbon material according to an embodiment of the present disclosure may contain C, H, and Si, and additionally, nitrogen (N). N can be contained in an a-C:H:Si film or a-C:H:Si:O film by irradiating the film with nitrogen plasma.

An a-C:H:O film, a-C:H:N film, or a-C:H:O:N film may be formed by irradiating a prepared amorphous carbon film free of Si with one or both of oxygen plasma and nitrogen plasma. The plasma irradiation can be carried out subsequently to or simultaneously with formation of the amorphous carbon film in the same apparatus as that for forming the amorphous carbon film without vacuum break. The plasma-treated surface of the amorphous carbon film has various functional groups such as Si—OH, —COO—, or —COOH—, and these functional groups may undergo condensation reaction with the functional groups contained in a fluorine-containing silane coupling agent (described later), so as to further enhance adhesion of the fluorine-containing silane coupling agent (described later) to the surface of the amorphous carbon film. Also, the surface layer of the amorphous carbon film may be provided with a polarity by applying oxygen plasma or nitrogen plasma. This may enable tight binding between polarized amorphous carbon film and the fluorine-containing silane coupling agent by hydrogen bonding.

A thin film 20 of a fluorine-containing silane coupling agent may be formed on at least part of the amorphous carbon film on a surface of the mesh 16. The thin film 20 of a fluorine-containing silane coupling agent may be tightly fixed to the amorphous carbon film formed on a surface of the mesh 16 by a chemical bond such as a covalent bond due to a dehydration condensation reaction or a hydrogen bond. A product “FG-5010Z130-0.2” manufactured by Fluoro Technology Corporation can be, for instance, used as the fluorine-containing silane coupling agent. In an embodiment, the thin film 20 may be formed so as to have a small thickness which has substantially no influence on the volume of printing paste which passes through the printing pattern opening 18; for example, the thickness may be approximately 20 nm. The thickness of the thin film 20 is not limited thereto and can be appropriately changed depending on types of fluorine-containing silane coupling agent to be used; for instance, the thickness may range from 1 nm to 1 μm.

The thin film 20 formed of the fluorine-containing silane coupling agent may be formed on the amorphous carbon film by various methods. For example, the thin film 20 may be applied onto the mesh 16 having formed thereon an amorphous carbon film by using fabrics such as unwoven fabrics, a sponge, a sponge-like roller, and a brush. Also, the thin film 20 may be formed by spraying the fluorine-containing silane coupling agent. The thin film 20 may be formed by other various methods including dipping and evaporation methods such as resistance heating.

The fluorine-containing coupling agent may refers to a coupling agent exhibiting water- and oil-repellence and including a substituent group of fluorine in the molecular structure thereof. The fluorine-containing coupling agents that can be used for the thin film 20 may include the following.

CF3(CF2)7CH2CH2Si(OCH3)3 (i)

CF3(CF2)7CH2CH2SiCH3Cl2 (ii)

CF3(CF2)7CH2CH2SiCH3(OCH3)2 (iii)

(CH3)3SiOSO2CF3 (iv)

CF3CON(CH3)SiCH3 (v)

CF3CH2CH2Si(OCH3)3 (vi)

CF3CH2SiCl3 (vii)

CF3(CF2)5CH2CH2SiCl3 (viii)

CF3(CF2)5CH2CH2Si(OCH3)3 (ix)

CF3(CF2)7CH2CH2SiCl3 (x)

These fluorine-containing coupling agents are non-limiting examples of fluorine-containing coupling agents applicable to the present disclosure. The applicable fluorine-coupling agents may include, for example, FG-5010Z130-0.2 (containing 0.02-0.2% fluorine resin and 99.8-99.98% fluorine-based solvent) from Fluoro Technology Corporation.

The thin film 20 may have two-layer structure including a first layer composed mainly of a coupling agent and a second layer composed mainly of a water repellent material or a water- and oil-repellent material The first layer may be a thin film composed of, for example, a coupling agent that can form, with the amorphous carbon film layer, hydrogen bonding and/or an —O-M bonding (M is any one element selected from the group consisting of Si, Ti, Al, and Zr) by condensation reaction, on the amorphous carbon film on the surface of the mesh 16. Such coupling agents may include, for example, silane coupling agent, titanate-based coupling agent, aluminate-based coupling agent, and zirconate-based coupling agent. These coupling agents may be used combinedly with other coupling agents. The second layer may be a thin film composed of a water repellent material, for example, alkylchlorosilanes such as methyltrichlorosilane, octyltrichlorosilane, and dimethyltrichlorosilane, alkylmethoxysilanes such as dimethyldimethoxysilane and octyltrimethoxysilane, hexamethyldisilazane, a silylation agent, and silicone. Also, the thin film composed of the above fluorine-containing silane coupling agent may be used as the second layer. The water repellent materials or water- and oil-repellent materials that can be used as the second layer are not limited to those explicitly described herein. The material of the thin film 20 may be appropriately selected in accordance with various printing conditions such as the composition (water-based or oil-based), viscosity, and thixotropy of the printing paste and ink, and the temperature and humidity in printing.

Silane coupling agents are widely used; and this requires no example to be cited. Various silane coupling agents commercially available can be used as the first layer of the thin film 20. One example of the silane coupling agent applicable to the present disclosure is decyltrimethoxysilane (trade name “KBM-3103” from Shin-Etsu Chemical Co., Ltd.).

The titanate-based coupling agents constituting the thin film 20 may include tetramethoxytitanate, tetraethoxytitanate, tetrapropoxytitanate, tetraisopropoxytitanate, tetrabutoxytitanate, isopropyltriisostearoyltitanate, isopropyltridecylbenzenesulfonyltitanate, isopropyl tris(dioctyl pyrophosphate)titanate, tetraisopropyl bis(dioctylphosphite)titanate, tetra(2,2-diaryloxymethyl-1-butyl)bis(ditridecyl)phosphite titanate, bis(dioctylpyrophosphate)oxyacetate titanate, bis(dioctylpyrophosphate)ethylene titanate, isopropyltrioctanoyltitanate, and isopropyltricumylphenyltitanate. The product named “Plenact 38S” (from Ajinomoto Fine-Techno Co., Inc.) is commercially available.

The aminate-based coupling agents constituting the thin film 20 may include aluminum alkyl acetoacetate diisopropylate, aluminum ethyl acetoacetate diisopropylate, aluminum trisethyl acetoacetate, aluminum isopropylate, aluminum diisopropylate monosecondary butylate, aluminum secondary butylate, aluminum ethylate, aluminum bisethyl acetoacetate monoacetyl acetonate, aluminum trisacetyl acetonate, and aluminum monoisopropoxy monooleoxy ethyl acetoacetate. The product named “Plenact AL-M” (alkyl acetate aluminum diisopropylate from Ajinomoto Fine-Techno Co., Inc.) is commercially available.

The zirconia-based coupling agents constituting the thin film 20 may include neopentyl(diaryl)oxy, trimethacryl zirconate, tetra(2,2 diaryloxy methyl)butyl, di(ditridecyl)phosphate zirconate, and cyclo[dineopentyl(diaryl)]pyrophosphate dineopentyl(diaryl)zirconate. The product named “Ken-React NZ01” (from Kenrich Petrochemicals, Inc.) is commercially available.

In the embodiment of the present disclosure as described above, a water- and oil-repellent layer composed of fluorine-containing silane coupling agent may be formed on the amorphous carbon film formed by plasma CVD method; therefore, the openings in the mesh 16 may be inhibited from being blocked as compared to conventional techniques that involves application of a liquid primer onto the mesh 16. The amorphous carbon film thus formed may tightly bind to fluorine-containing silane coupling agent; therefore, the fluorine-containing silane coupling agent may be applied with excellent fixity on the portion of the mesh 16 that is exposed from the printing pattern openings 18. Additionally, in an embodiment of the present disclosure, the thin film 20 composed of fluorine-containing silane coupling agent may be formed on a portion of the mesh 16 that is exposed from the printing pattern openings 18 after an emulsion 14 is applied to the mesh 16. Accordingly, the emulsion 14 may be applied to the mesh 16 with better fixity, as compared to the case where the thin film 20 is formed on the entirety of the mesh 16 before the emulsion 14 is applied. Further, the amorphous carbon film according to an embodiment of the present disclosure may retain the emulsion 14 with excellent fixity. Accordingly, in the embodiment of the present disclosure, the demoldability of the printing paste from the mesh 16 may be enhanced, and the printing pattern may be accurately formed on a printing medium.

In an embodiment of the present disclosure, the amorphous carbon film may be formed on the mesh 16 with plasma (process) having a high straightness. Thus, the amorphous carbon film according to an embodiment of the present disclosure is less prone to spread behind the substrate (e.g., the mesh 16) or into other irrelevant portions, unlike a liquid primer. Accordingly, in an embodiment of the present disclosure, a primer layer composed of an amorphous carbon film can be formed selectively only on a desired surface of the substrate (e.g., a print substrate surface of a stencil printing plate on which to develop a water- and oil-repellent layer). For example, if water- and oil-repellence is provided to a squeegee surface of a stencil printing plate where to load printing paste, blurred printing or other troubles may occur. In an embodiment of the present disclosure, a primer layer of an amorphous carbon film may be formed by a plasma process having a high straightness; therefore, a primer layer may be formed selectively on a surface opposite to the squeegee surface.

Additionally, an amorphous carbon film may have a transmission barrier quality against H2O and O2. The fluorine-containing silane coupling agent is water-repellent and thus prevents moisture from being adsorbed. The amorphous carbon film structure of the present disclosure and the structure further having a fluorine layer on the surface layer may prevent H2O from penetrating into the substrate as compared to conventional amorphous carbon film. Accordingly, the mesh 16 may be better protected from H2O and O2; and this may prevent removal of the amorphous carbon film caused by a degraded substrate.

The amorphous carbon film according to an embodiment of the present disclosure may exhibit a higher hydrophilicity than ordinary amorphous carbon films; therefore, it may promote spreading of the emulsion, which is generally water-soluble, onto the surface of the mesh and inhibit bubbles from occurring in the interface between the emulsion and the mesh. This may inhibit the weakening of the emulsion caused by the bubbles occurring in the interface between the emulsion and the mesh.

Also, the amorphous carbon film may inhibit an applied ultraviolet light from being reflected or scattered. Accordingly, when printing pattern openings 18 are formed in the emulsion 14 with a drawing device using ultraviolet light, the applied ultraviolet light may be inhibited from being reflected or scattered from the mesh 16, and the accuracy in dimensions of the printing pattern openings 18 may be increased.

The screen printing plate 10 according to an embodiment of the present disclosure having such a configuration may be disposed such that the lower surface 26 of the emulsion 14 faces a printing medium. After the screen printing plate 10 is disposed at a predetermined position, printing paste, such as solder paste or metallic paste for forming an inner electrode, may be applied onto an upper surface 24, and then a squeegee (not illustrated) may be slid along the upper surface 24 while the upper surface 24 is pressed by the squeegee at a certain level of pressure, so that the applied printing paste passes through the printing pattern opening 18 and is then transferred to the printing medium. In addition to these printing pastes, the screen printing plate 10 may be used to transcribe printing ink, dye, paint, antirust, adhesive, reactive material, slurry for green sheets, resist for lithography, pressure-sensitive material, temperature-sensitive material, and adsorbent.

The mesh 16 may also be applied to a stencil printing plate that can be used in printing other than screen printing (transcription). The mesh 16 may be applied to, for example, a stencil printing plate for pressure printing, in which an ink forced by a pressure mechanism such as an ink jet mechanism is transferred to a printing medium, and vacuum printing, in which an ink is transferred to a printing medium provided with a lower pressure. The printing methods that can utilize the stencil printing plate using the mesh 16 having formed thereon an amorphous carbon film of the present disclosure are not limited to those stated herein.

An example of a method for manufacturing the screen printing plate 10 will now be described. The frame 12 made from cast iron, stainless steel, or aluminum alloy and the mesh 16 having a surface on which the amorphous carbon film may be formed by a plasma CVD method or another technique are prepared, and the mesh 16 may be attached to the frame 12. The mesh 16 may be directly attached to the frame 12 or indirectly attached via a support screen. Then, the sensitive emulsion 14 may be applied to the mesh 16, and the printing pattern opening 18 corresponding to a print pattern may be formed in the emulsion 14 by a photolithographic method. Then, the thin film 20 of a fluorine-containing silane coupling agent may be formed on the lower surface 26 of the mesh 16 exposed in the printing pattern opening 18 to complete the screen printing plate 10.

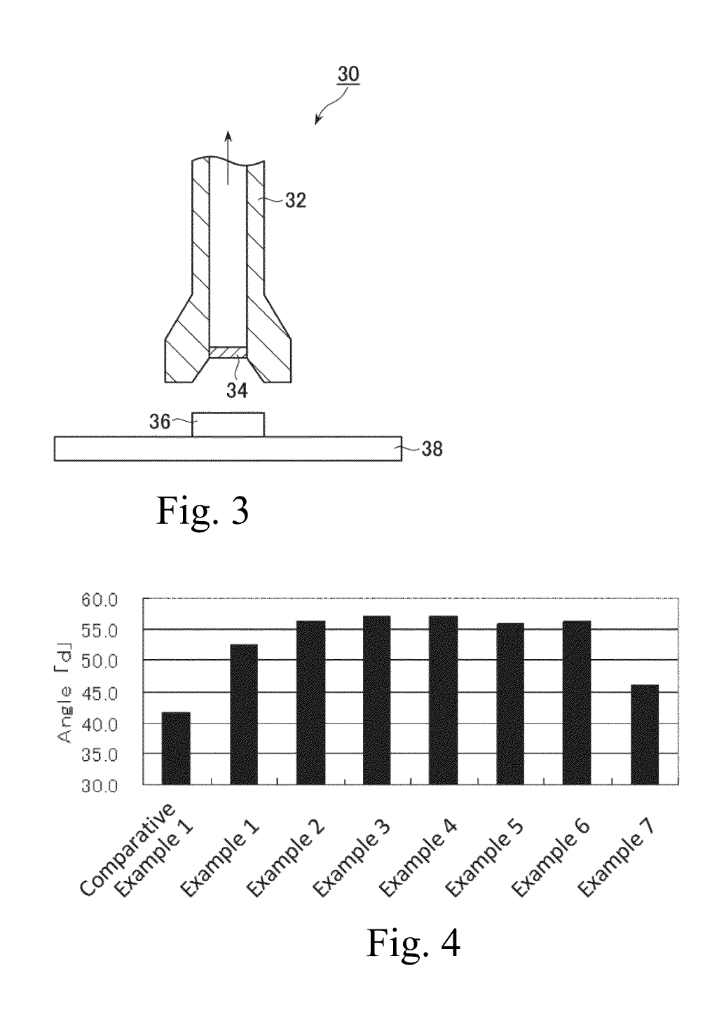

FIG. 3 is a schematic view illustrating a part of an adsorbing collet installed on an electronic component conveyor 30 having a porous sheet according to an embodiment of the present disclosure. The adsorbing collect 32 may be installed on a desired electronic component conveyor so as to be movable vertically and horizontally. As shown, the adsorbing collet 32 may be tubularly shaped with one end thereof being connected to a negative-pressure source not shown. Near an adsorbing port of the adsorbing collet 32 may be provided a porous sheet 34 according to an embodiment of the present disclosure. An electronic component 36 may rest on a wafer sheet 38. When this electronic component 36 is conveyed from the wafer sheet to another working space, the adsorbing collet 32 may be positioned on the electronic component 36 and a negative pressure may be supplied from the negative-pressure source; thus, the electronic component 36 may be adsorbed near the adsorbing port of the adsorbing collect 32. Next, the adsorbing collet 36 having adsorbed thereon the electronic component 36 may be moved to a working space, where the supply of the negative pressure may be stopped; thus, the electronic component 36 may be conveyed to the working space. Such an adsorbing collet 32 is disclosed in, for example, Japanese Patent Application Publication No. 2011-014582 and is obvious to those skilled in the art as to detailed configuration and operations thereof. The detailed description of the above collet 32 will be omitted herein. Additionally, the adsorbing collet 32 may be used for conveying various components other than electronic components, such as a green sheet.

The porous sheet 34 may be composed of, for example, a synthetic resin such as polypropylene, a metal such as stainless steel, a ceramic such as zirconia, a breathable fabric such as bandage, an unwoven fabric, or a combination thereof; and the porous sheet 34 may include openings as the above screen printing mesh 16. On the surface of the porous sheet 34 may be provided an amorphous carbon film according to an embodiment of the present disclosure as a primer layer; and on this amorphous carbon film may be applied a fluorine-containing silane coupling agent. The amorphous carbon film may contain at least one element of silicon, oxygen, and nitrogen. The amorphous carbon film may be formed by the same method to have the same composition as the above amorphous carbon film formed on the mesh 16. Accordingly, the primer layer composed of the amorphous carbon film according to an embodiment of the present disclosure may be formed so as not to block the openings of the porous sheet 34. The amorphous carbon film according to an embodiment of the present disclosure may be formed selectively on the portion of the porous sheet 34 where the electronic component 36 is adsorbed. Thus, no amorphous carbon film (or fluorine-containing silane coupling agent) may be formed on the contact portion between the porous sheet 34 and the adsorbing collet 32; and thus the adhesion between the porous sheet 34 and the adsorbing collet 32 may be ensured.

The porous sheet 34 may tightly retain the fluorine-containing silane coupling agent with an amorphous carbon film according to an embodiment of the present disclosure serving as a primer layer; therefore, the porous sheet 34 may have a smooth surface characteristics, have a low friction coefficient and aggressiveness, prevent adhesion to a soft metal such as tin and aluminum, and have a high wear resistance. Thus, when the electronic component 36 is being conveyed, the electronic component 36 may be inhibited from being adhered to the porous sheet 34, and the pores in the porous sheet may be inhibited from being blocked with absorbed dust and foreign bodies; thus, the electronic component 36 can be efficiently conveyed. The porous sheet 34 may have unevenness in the surface thereof. The fluorine-containing silane coupling agent applied in the cavity may be protected by the amorphous carbon film formed on the convexity from the stress exerted from outside; therefore, the endurance of the water- and oil-repellence of the porous sheet 34 may be very high.

The above screen printing mesh and the porous sheet for electronic component conveyor are mere examples to which the primer composition composed of the amorphous carbon material of the present disclosure is applied. The primer composition composed of the amorphous carbon material of the present disclosure may be used for any type of works that may suffer blocking by a liquid primer.

### EXAMPLES

It was confirmed by the following method that the fluorine-containing silane coupling agent can be applied on an amorphous carbon film with excellent fixity in an embodiment of the present disclosure. First, samples (Examples 1 to 9) were prepared, each comprising an amorphous carbon film composed of at least one element of Si, O, and N and formed on the surface of a stainless steel piece (SUS304, grade 2B), and the amorphous carbon film being provided with a fluorine coating (fluorine-containing silane coupling agent). Each of the samples was subjected to measurement of contact angles with mineral spirit (oil) and water (pure water) to analyze the fixity of the fluorine coating layer. If the fluorine-containing silane coupling agent is retained on the amorphous carbon film, the contact angle with the mineral spirit and water may be large because of the oil repellence and water repellence; therefore, it can be confirmed by measuring the contact angle whether the fluorine-containing silane coupling agent is retained on the amorphous carbon film.

1. Preparation of Samples

First, substrates composed of stainless steel (SUS304) to be used as the material of the mesh 16 were prepared for each sample. The prepared stainless steel (SUS304) substrates were rectangularly shaped with a side length of 30 mm, a thickness of 1 mm, and a surface roughness Ra of 0.034 μm. The stainless steel (SUS304) plates were subjected to electrolytic polishing to uniformly smoothen the surface of the substrates.

(1) Preparation of Sample for Example 1

Two of the stainless steel (SUS304) substrates described above were put into a high-pressure pulsed plasma CVD apparatus. The high-pressure pulsed plasma CVD apparatus was evacuated to 1×10⁻³ Pa, and then the substrates were cleaned with argon gas plasma for approximately 5 min. The conditions for cleaning with argon gas plasma were the same for all of Examples and Comparative Examples; that is, an argon gas flow rate of 15 SCCM, a gas pressure of 1 Pa, an applied voltage of −4 kV, a pulse frequency of 2 kHz, a pulse width of 50 μs, and a duration of 5 min. After the cleaning, argon gas was discharged, and then argon gas and tetramethylsilane were introduced into a reaction container at flow rates of 15 SCCM and 10 SCCM, respectively, such that the reaction container had an internal gas pressure of 1.5 Pa, and an amorphous carbon film was formed at an applied voltage of −4 kV, a pulse frequency of 2 kHz, and a pulse width of 50 μs for 30 min. A solution of a fluorine-containing silane coupling agent FG-5010Z130-0.2 (manufactured by Fluoro Technology Corporation) (containing 0.02 to 0.2% fluorine resin and 99.8 to 99.98% fluorine solvent) was applied onto a surface of the amorphous carbon film formed as described above through a dip coating process. The product was dried at room temperature and a humidity of about 50% for two days (the same conditions were also applied to the following Examples and Comparative Examples) to yield a sample for Example 1.

(2) Preparation of Sample for Example 2

Two of the stainless steel (SUS304) substrates described above were put into a high-pressure pulsed plasma CVD apparatus. The high-pressure pulsed plasma CVD apparatus was evacuated to 1×10⁻³ Pa, and then the substrates were cleaned with argon gas plasma for approximately 5 min. After the cleaning, argon gas was discharged, and then argon gas and tetramethylsilane were introduced into a reaction container at flow rates of 15 SCCM and 10 SCCM, respectively, such that the reaction container had an internal gas pressure of 1.5 Pa, and an amorphous carbon film was formed at an applied voltage of −4 kV, a pulse frequency of 2 kHz, and a pulse width of 50 μs for 30 min. Then, the source gas was discharged, and then oxygen gas was introduced into the reaction container at a flow rate of 14 SCCM such that the reaction container had an internal gas pressure of 1.5 Pa, and the amorphous carbon film was exposed to oxygen plasma at an applied voltage of −3 kV, a pulse frequency of 2 kHz, and a pulse width of 50 μs for 5 min. After the exposure to oxygen plasma, a solution of a fluorine-containing silane coupling agent FG-5010Z130-0.2 (manufactured by Fluoro Technology Corporation) (containing 0.02 to 0.2% fluorine resin and 99.8 to 99.98% fluorine solvent) was applied onto a surface of the amorphous carbon film through a dip coating process. The product was dried at room temperature for two days to yield a sample for Example 2.

(3) Preparation of Sample for Example 3

First, an amorphous carbon film was formed with argon and tetramethylsilane as in Example 1. Then, the source gas was discharged, and then nitrogen gas was introduced into the reaction container at a flow rate of 15 SCCM such that the reaction container had an internal gas pressure of 1.5 Pa, and the amorphous carbon film was exposed to nitrogen plasma at an applied voltage of −4 kV, a pulse frequency of 2 kHz, and a pulse width of 50 μs for 5 min. After the exposure to nitrogen plasma, a fluorine-containing silane coupling agent was applied to the amorphous carbon film thorough a dip coating process as in Example 1. The product was dried at room temperature for two days to yield a sample for Example 3.

(4) Preparation of Sample for Example 4

An amorphous carbon film was formed with argon and tetramethylsilane as in Example 1. Then, the source gas was discharged, and then nitrogen gas was introduced into the reaction container at a flow rate of 15 SCCM such that the reaction container had an internal gas pressure of 1.5 Pa, and the amorphous carbon film was exposed to nitrogen plasma at an applied voltage of −4 kV, a pulse frequency of 2 kHz, and a pulse width of 50 μs for 5 min. Then, the nitrogen gas was discharged, and then oxygen gas was introduced into the reaction container at a flow rate of 14 SCCM such that the reaction container had an internal gas pressure of 1.5 Pa, and the amorphous carbon film was exposed to oxygen plasma at an applied voltage of −3 kV, a pulse frequency of 2 kHz, and a pulse width of 50 is for 5 min. After the exposure to nitrogen plasma and oxygen plasma, a fluorine-containing silane coupling agent was applied to the amorphous carbon film thorough a dip coating process as in Example 1. The product was dried at room temperature for two days to yield a sample for Example 4.

(5) Preparation of Sample for Example 5

Two of the stainless steel (SUS304) substrates described above were put into a high-pressure pulsed plasma CVD apparatus. The high-pressure pulsed plasma CVD apparatus was evacuated to 1×10⁻³ Pa, and then the substrates were cleaned with argon gas plasma. After the cleaning, argon gas was discharged, and then tetramethylsilane and oxygen gas were introduced into a reaction container at flow rates of 15 SCCM and 0.7 SCCM, respectively, such that the reaction container had an internal gas pressure of 1.5 Pa, and an amorphous carbon film was formed at an applied voltage of −4 kV, a pulse frequency of 2 kHz, and a pulse width of 50 μs for 30 min. The proportion of the oxygen gas mixed with tetramethylsilane in the gas flow was adjusted to 4.5% with respect to the total gas flow. A fluorine-based silane coupling agent was applied to a surface of the amorphous carbon film formed in this manner thorough a dip coating process as in Example 1. The product was dried at room temperature for two days to yield a sample for Example 5.

(6) Preparation of Sample for Example 6

Two of the stainless steel (SUS304) substrates described above were put into a high-pressure pulsed plasma CVD apparatus. The high-pressure pulsed plasma CVD apparatus was evacuated to 1×10⁻³ Pa, and then the substrates were cleaned with argon gas plasma. After the cleaning, argon gas was discharged, and then tetramethylsilane and oxygen gas were introduced into a reaction container at flow rates of 15 SCCM and 1.4 SCCM, respectively, such that the reaction container had an internal gas pressure of 1.5 Pa, and an amorphous carbon film was formed at an applied voltage of −4 kV, a pulse frequency of 2 kHz, and a pulse width of 50 μs for 30 min. The proportion of the oxygen gas mixed with tetramethylsilane in the gas flow was adjusted to 8.5%. A fluorine-based silane coupling agent was applied to a surface of the amorphous carbon film formed in this manner thorough a dip coating process as in Example 1. The product was dried at room temperature for two days to yield a sample for Example 6.

(7) Preparation of Sample for Example 7

Two of the stainless steel (SUS304) substrates described above were put into a high-pressure pulsed plasma CVD apparatus. The high-pressure pulsed plasma CVD apparatus was evacuated to 1×10⁻³ Pa, and then the substrates were cleaned with argon gas plasma. After the cleaning, argon gas was discharged, and then argon and tetramethylsilane were introduced into a reaction container at flow rates of 15 SCCM and 10 SCCM, respectively, such that the reaction container had an internal gas pressure of 1.5 Pa, and an amorphous carbon film was formed at an applied voltage of −4 kV, a pulse frequency of 2 kHz, and a pulse width of 50 μs for about 10 min. Through this process, a Si-containing amorphous carbon film was formed as an underlying interlayer on a surface of the substrate. Next, argon gas and tetramethylsilane were discharged, and then acetylene was introduced into a reaction container at a flow rate of 20 SCCM such that the reaction container had an internal gas pressure of 1.5 Pa, and an amorphous carbon film was formed at an applied voltage of −4 kV, a pulse frequency of 2 kHz, and a pulse width of 50 μs for 30 min. Through this process, a Si-free amorphous carbon film was formed on a surface of the underlying interlayer. After the source gas was discharged, oxygen gas was introduced into the reaction container at a flow rate of 14 SCCM such that the reaction container had an internal gas pressure of 1.5 Pa, and the amorphous carbon film was exposed to oxygen plasma at an applied voltage of −4 kV, a pulse frequency of 2 kHz, and a pulse width of 50 μs for 5 min. After the exposure to oxygen plasma, a fluorine-containing silane coupling agent was applied to a surface of the amorphous carbon film thorough a dip coating process as in Example 1. The product was dried at room temperature for two days to yield a sample for Example 7.

(8) Preparation of Sample for Example 8

As in Example 7, a Si-containing amorphous carbon film was formed as an underlying interlayer on a stainless steel (SUS304) substrate, and a Si-free amorphous carbon film was formed on a surface of the underlying interlayer. In this embodiment, after the source gas was discharged, nitrogen gas was introduced into the reaction container at a flow rate of 14 SCCM such that the reaction container had an internal gas pressure of 1.5 Pa, and the amorphous carbon film was exposed to nitrogen plasma at an applied voltage of −4 kV, a pulse frequency of 2 kHz, and a pulse width of 50 μs for 5 min. After the exposure to nitrogen plasma, a fluorine-based silane coupling agent was applied to a surface of the amorphous carbon film thorough a dip coating process as in Example 1. The product was dried at room temperature for two days to yield a sample for Example 8.

(9) Preparation of Sample for Example 9

As in Example 7, a Si-containing amorphous carbon film was formed as an underlying interlayer on a stainless steel (SUS304) substrate, and a Si-free amorphous carbon film was formed on a surface of the underlying interlayer. In this embodiment, after the source gas was discharged, nitrogen gas was introduced into the reaction container at a flow rate of 14 SCCM such that the reaction container had an internal gas pressure of 1.5 Pa, and the amorphous carbon film was exposed to nitrogen plasma at an applied voltage of −4 kV, a pulse frequency of 2 kHz, and a pulse width of 50 μs for 5 min. Then, the nitrogen gas was discharged, and then oxygen gas was introduced into the reaction container at a flow rate of 14 SCCM such that the reaction container had an internal gas pressure of 1.5 Pa, and the amorphous carbon film was exposed to oxygen plasma at an applied voltage of −3 kV, a pulse frequency of 2 kHz, and a pulse width of 50 μs for 5 min. After the exposure to nitrogen plasma and oxygen plasma, a fluorine-containing silane coupling agent was applied to a surface of the amorphous carbon film thorough a dip coating process as in Example 1. The product was dried at room temperature for two days to yield a sample for Example 9.

(10) Preparation of Sample for Comparative Example 1

As in Example 7, a Si-containing amorphous carbon film was formed as an underlying interlayer on an SUS304 substrate. In the present comparative example, the source gas was discharged, acetylene was subsequently introduced into a reaction container at a flow rate of 20 SCCM such that the reaction container had an internal gas pressure of 1.5 Pa, and then a film was formed at an applied voltage of −4 kV, a pulse frequency of 2 kHz, and a pulse width of 50 μs for 30 min. Through this process, a Si-free amorphous carbon film was formed on the underlying interlayer. A fluorine-containing silane coupling agent was applied to the Si-free amorphous carbon film thorough a dip coating process as in Example 1. The product was dried at room temperature for two days to yield a sample for Comparative Example 1.

2. Measurement of Wettability

Each of the samples for Examples 1 to 7 and Comparative Example 1 was subjected to measurement of wettability to mineral spirit (oil). The measurement was carried out with a portable contact angle analyzer “PG-X” (mobile contact angle tester) from FIBRO System AB, at a room temperature of 25° C. and a humidity of 30%. In order to analyze the fixity of a fluorine-containing silane coupling agent to an amorphous carbon film, each of the samples for Examples 1 to 7 and Comparative Example 1 was put into acetone and subjected to ultrasonic cleaning for 120 min, and then each sample was subjected to measurement of a contact angle with mineral spirit after the ultrasonic cleaning. In the ultrasonic cleaning process, each sample was continuously subjected to ultrasonic cleaning for 60 min, and subsequently allowed to stand for 60 min without the ultrasonic cleaning, and then further subjected to ultrasonic cleaning for 60 min. Since it was assumed that the fluorine-containing silane coupling agent in the sample for Comparative Example 1 would be removed in a short time during the ultrasonic cleaning, the sample for Comparative Example 1 was subjected to the ultrasonic cleaning only for 5 min, and a contact angle was measured after the 5-min ultrasonic cleaning. The ultrasonic cleaning was carried out with an ultrasonic cleaner (product name “US-20KS”, commercially available from SND Co., Ltd., oscillation: 38 kHz (bolt-clamped Langevin type transducer (BLT) self-oscillation), high-frequency output: 480 W). In the ultrasonic cleaning, the vibration of a piezoelectric vibrator generated cavitation (air bubbles) in acetone, and the air bubbles were broken at a surface of the substrate while applying large physical impact force on the surface of the substrate, resulting in the removal of a fluorine-containing silane coupling agent weakly bound to the amorphous carbon film from the surface of the substrate. Hence, measurement of a contact angle at the surface of the substrate subjected to the ultrasonic cleaning enabled analysis of the adhesion between a fluorine-containing silane coupling agent and the underlying amorphous carbon film.

FIG. 4 is a graph illustrating results of the measurement of a contact angle with mineral spirit in Examples 1 to 7 and Comparative Example 1, and each result shows the average value of contact angles determined at 16 points on the substrate. The graph elucidates that the sample for Comparative Example 1 after the ultrasonic cleaning for 5 min exhibited a reduction in a contact angle to approximately 40°. In contrast, each of the samples for Examples 1 to 7 exhibited a contact angle of not less than 45° even after the ultrasonic cleaning for 120 min. Also, each of the samples for Examples 1 to 7 exhibited sufficient oil repellence in the contact angles measured at the measurement points; and at no measurement point a low contact angle indicating loss of oil repellence was measured. Particularly, each of the samples for Examples 1 to 6 having the Si-containing amorphous carbon film exhibited an average contact angle of not less than 50°. Each result of the measurement demonstrates that a sufficient amount of fluorine-containing silane coupling agent was remaining on a surface of the sample to exhibit a water-oil-repellent property.

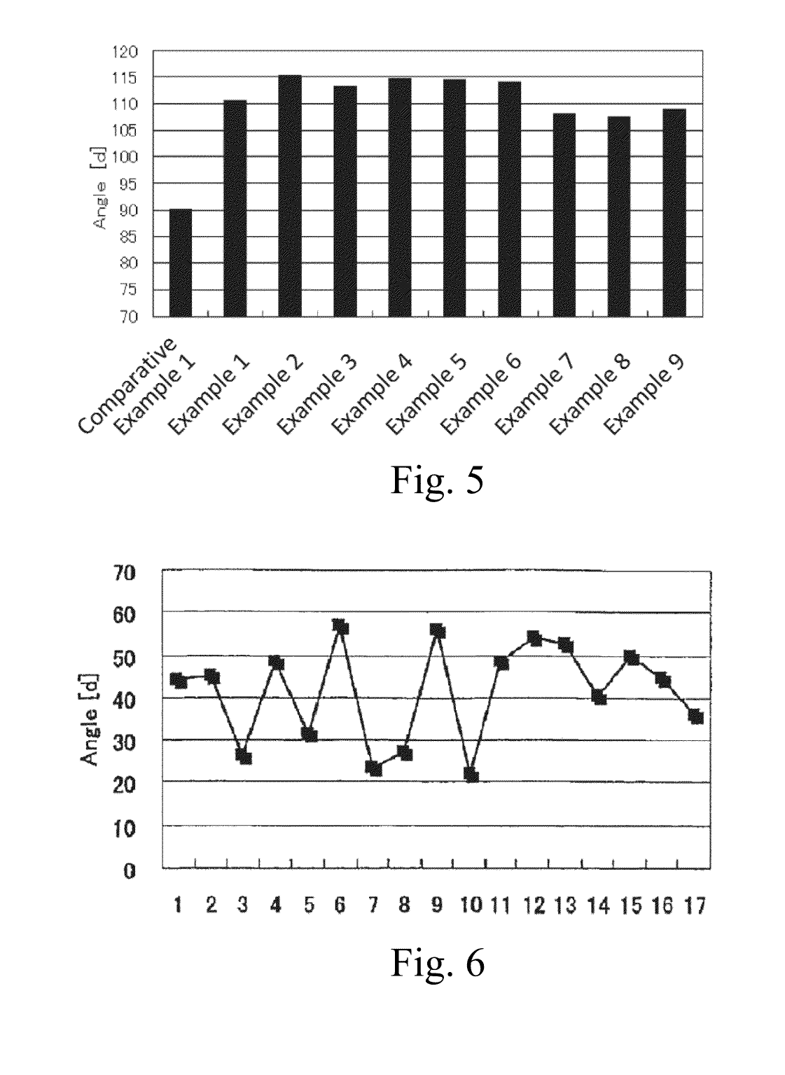

Next, wettability to water (pure water) was measured. The measurement was carried out with the same instrument and in the same environment as in the measurement of wettability to mineral spirit. Each of the samples for Examples 1 to 9 and Comparative Example 1 was put into acetone and then subjected to ultrasonic cleaning for 5 min, and then each sample was subjected to measurement of a contact angle with water after the ultrasonic cleaning. FIG. 5 is a graph illustrating results of the measurement of a contact angle with water in Examples 1 to 9 and Comparative Example 1, and each result shows the average value of contact angles determined at 10 points on a substrate. The graph elucidates that Comparative Example 1 exhibited a contact angle of approximately 90°; in contrast, each of Examples 1 to 9 exhibited a contact angle of not less than 105°. Each result of the measurement demonstrates that a sufficient amount of fluorine-containing silane coupling agent was remaining on a surface of the sample to exhibit a water-oil-repellent property.

These results demonstrate that application of the film structures of Examples 1 to 9 to a screen printing mesh enhances the demoldability of the printing paste from the mesh and reduces the residual paste on the mesh, the film structures each including the amorphous carbon film and the fluorine-containing silane coupling agent.

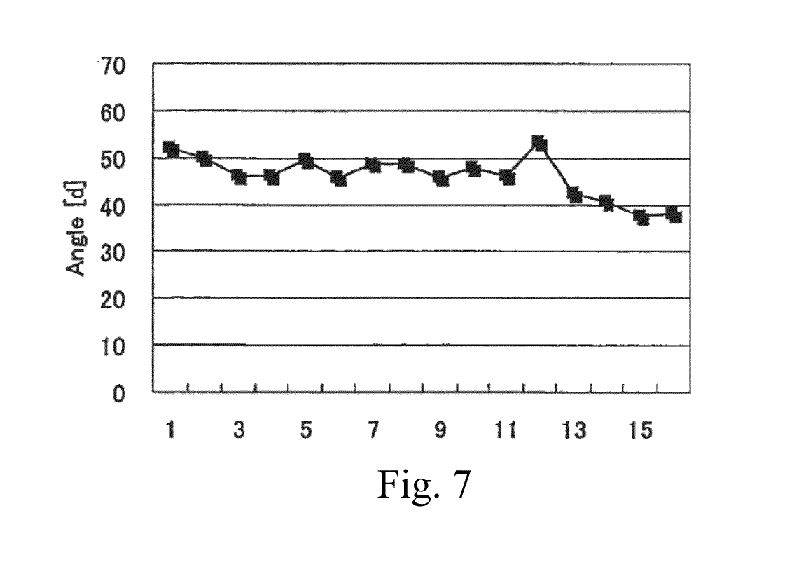

FIG. 6 is a graph illustrating results of the measurement of a contact angle with mineral spirit in Comparative Example 1 after the ultrasonic cleaning for 5 min, the measurement being carried out at multiple points (measurement points) on a surface of the sample for Comparative Example 1. FIG. 7 is a graph illustrating results of the measurement of a contact angle with mineral spirit in Example 7 after the ultrasonic cleaning for 120 min, the measurement being carried out at multiple points (measurement points) on a surface of the sample for Example 7. FIGS. 6 and 7 elucidate that Comparative Example 1 exhibited a large variation in contact angles (Max-Min) depending on the measurement points, and thus the fluorine-containing silane coupling agent was partially removed. Example 7 exhibited relatively even contact angles.

In each of Examples 2 to 6, after the formation of the silicon-containing amorphous carbon film, the silicon-containing source gas was discharged, oxygen and/or nitrogen was subsequently introduced, and then the exposure to plasma was carried out, without vacuum break in a reaction container; however, the reaction container may be returned to a normal pressure state after the formation of the silicon-containing amorphous carbon film, and then the reaction container may be brought into a vacuum state again for introduction of oxygen and/or nitrogen. Even in the case where the reaction container was returned to a normal pressure state before the exposure to plasma in this manner, contact angles with water and mineral spirit were substantially the same as those in the above Examples.

Next, it was confirmed by the following process that the openings in the mesh according to an embodiment of the present disclosure were substantially not blocked by the printing paste. First, stainless steel pieces were cut to prepare three meshes (#500-19) with a size of 210 mm by 210 mm. The meshes include 500 stainless steel wire rods per one inch width, and the stainless steel wire rods have a diameter of 19 μm. The openings of the meshes have a width of about 30 μm. These meshes (#500-19) are commercially available. An emulsion was applied to the meshes (#500-19), and a printing pattern for an electronic circuit was formed in the emulsion, such that part of the meshes was exposed from through-halls in the printing pattern (e.g., printing pattern openings 18).

Next, one of the prepared three meshes (#500-19) were adhered to four sides of an iron casting frame having a size of 320 mm by 320 mm. Next, the frame was horizontally positioned, and the mesh (#500-19) was coated with a liquid primer for fixing the fluorine-containing silane coupling agent and a primer coat PC-2 dedicated to Fluorosurf from Fluoro Technology Corporation, both soaking BEMCOT CLEANWIPE-P (unwoven fabric) from Asahi Kasei Corporation. Next, the frame coated with the primer coat PC-2 was horizontally positioned in a thermostat oven at room temperature and a humidity of 50%, and was dried for 60 minutes to obtain the sample for Comparative Example 2.

Another of the prepared three meshes (#500-19) was cut to a size of 70 mm by 30 mm, and was coated with the primer PC-2 from Fluoro Technology Corporation by flow coating. The mesh (#500-19) coated with the primer PC-2 was vertically positioned in a thermostat oven at room temperature and a humidity of 50%, and was dried for 60 minutes to obtain the sample for Comparative Example 3.

On the remaining one of the prepared three meshes (#500-19), an amorphous carbon film was formed by the following process. First, the mesh (#500-19) was set to an electrode of a high-pressure pulsed plasma CVD apparatus, and the CVD apparatus was evacuated of air. A reaction container of the CVD apparatus was evacuated to 1×10⁻³ Pa, and then the mesh (#500-19) was cleaned with argon gas plasma for five minutes. The cleaning with argon gas plasma was carried out at an argon gas flow rate of 30 SCCM, a gas pressure of 2 Pa, an applied voltage of −4 kV, a pulse frequency of 10 kHz, and a pulse width of 10 μs. After the cleaning, argon gas was discharged, and then trimethylsilane was introduced into the reaction container at flow rate of 30 SCCM such that the reaction container had an internal gas pressure of 1.5 Pa, and an amorphous carbon film containing Si was formed on the mesh (#500-19) at an applied voltage of −4 kV, a pulse frequency of 10 kHz, and a pulse width of 10 μs for 30 min. Then, the mesh (#500-19) was adhered to an iron casting frame as with Comparative Example 2. The frame having adhered thereto the mesh (#500-19) on which the amorphous carbon film primer layer was formed was horizontally positioned in a thermostat oven at room temperature and a humidity of 50% as with Comparative Example 2, and was dried for 60 minutes to obtain the sample for Example 10.

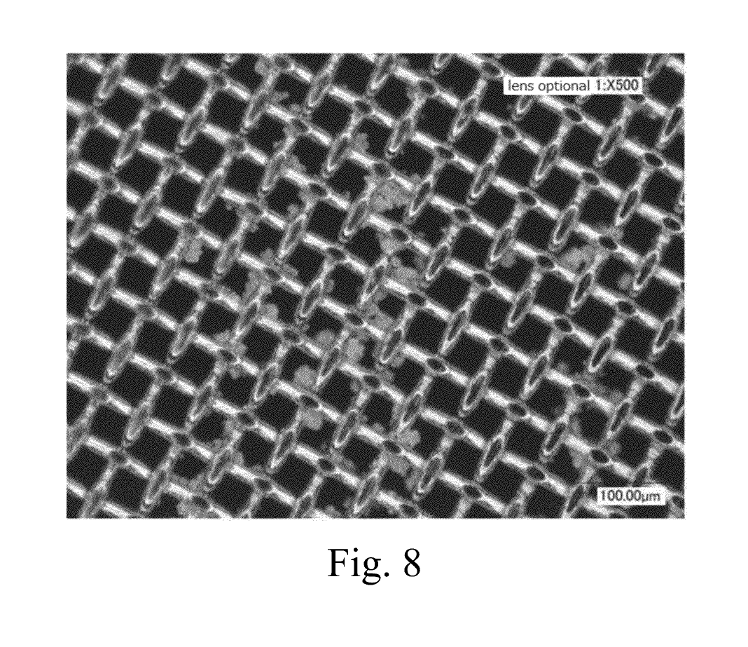

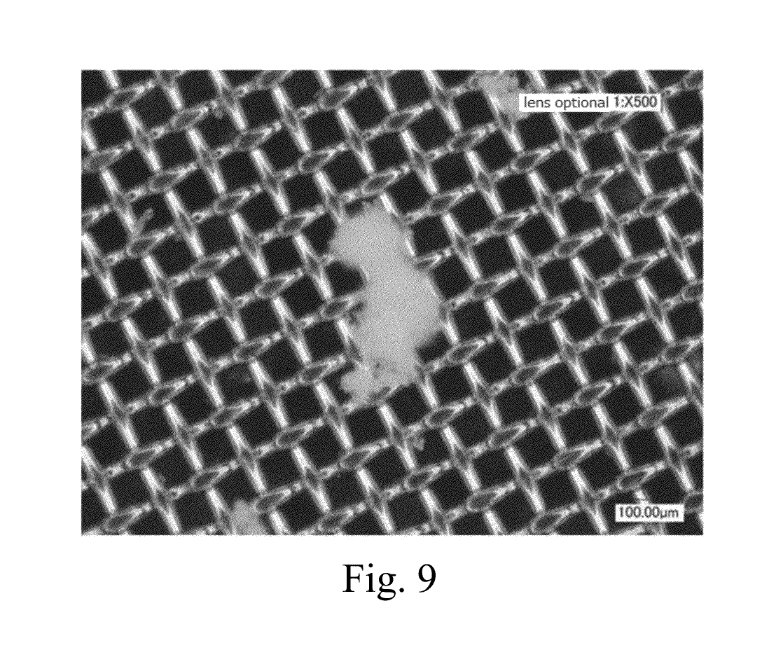

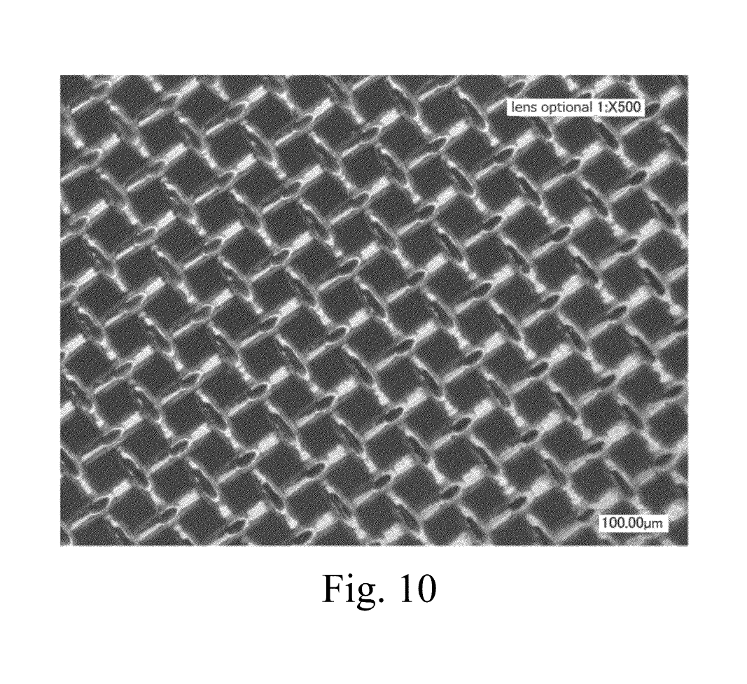

Next, the samples for Comparative Examples 2 and 3 and Example 10 were photographed with a CCD camera to confirm whether the mesh openings in the samples were blocked FIGS. 8 and 9 are photographs of these samples taken by the CCD camera at a magnification of 500. FIG. 8 is a photograph of Comparative Example 2; FIG. 9 is a photograph of Comparative Example 3; and FIG. 10 is a photograph of Example 10. As shown in the photographs of FIGS. 8 and 9, the liquid primer PC-2 spreads into the openings in the meshes of the samples for Comparative Examples 2 and 3 to block part of the openings. In contrast, the photograph of FIG. 10 shows that no opening was blocked by the primer layer of the amorphous carbon film in the sample for Example 10.

Thus, no opening is blocked in the screen printing mesh according to an embodiment of the present disclosure.

Next, it was confirmed by the following process that the mesh according to an embodiment of the present disclosure tightly binds with an emulsion. First, two stainless steel rectangular meshes (#500-19) with a size of 300 mm by 300 mm were prepared. An amorphous carbon film was formed on one of these meshes (#500-19) by the following process. First, the prepared mesh (#500-19) was introduced into a high-pressure pulsed plasma CVD apparatus, and the CVD apparatus was evacuated to 1×10⁻³ Pa. Next, argon gas was introduced into the CVD apparatus after the evacuation at a flow rate of 30 SCCM and a gas pressure of 2 Pa, and the mesh (#500-19) was cleaned with argon gas plasma at an applied voltage of −4 kV, a pulse frequency of 10 kHz, and a pulse width of 10 μs. Next, after argon gas was discharged, trimethylsilane was introduced into the CVD apparatus at a flow rate of 30 SCCM and a gas pressure of 2 Pa, and an amorphous carbon film containing Si was formed on the surface of the mesh (#500-19) at an applied voltage of −4 kV, a pulse frequency of 10 kHz, and a pulse width of 10 μs for 10 min. Next, trimethylsilane gas was discharged from the CVD apparatus, and then oxygen gas was introduced into the CVD apparatus at a flow rate of 30 SCCM and a gas pressure of 2 Pa, and the mesh (#500-19) having formed thereon the amorphous carbon film was irradiated with oxygen plasma at an applied voltage of −3 kV, a pulse frequency of 10 kHz, and a pulse width of 10 μs for 3 min to obtain the sample for Example 12 (Example 11 is omitted). The amorphous carbon film of the sample for Example 12 contains Si and O.

An amorphous carbon film was formed on the remaining one of the meshes (#500-19) by the following process. First, the prepared mesh (#500-19) was introduced into a high-pressure pulsed plasma CVD apparatus, and the CVD apparatus was evacuated to 1×10⁻³ Pa. Next, argon gas was introduced into the CVD apparatus after the evacuation at a flow rate of 30 SCCM and a gas pressure of 2 Pa, and the mesh (#500-19) was cleaned with argon gas plasma at an applied voltage of −4 kV, a pulse frequency of 10 kHz, and a pulse width of 10 μs. Next, after argon gas was discharged, trimethylsilane was introduced into the CVD apparatus at a flow rate of 30 SCCM and a gas pressure of 2 Pa, and an amorphous carbon film constituting an intermediate layer was formed on the surface of the mesh (#500-19) at an applied voltage of −4 kV, a pulse frequency of 10 kHz, and a pulse width of 10 μs for 5 min. Next, the trimethylsilane gas was discharged from the CVD apparatus, and then acetylene gas was introduced into the CVD apparatus at a flow rate of 30 SCCM and a gas pressure of 2 Pa, and an amorphous carbon film substantially free of Si, O, and N was formed on the mesh (#500-19) having formed thereon the amorphous carbon film constituting an intermediate layer at an applied voltage of −4 kV, a pulse frequency of 10 kHz, and a pulse width of 10 μs for 6 min, to obtain the sample for Comparative Example 4. The amorphous carbon film exposed in the surface of the sample for Comparative Example 4 is substantially free of Si, O, and N except those adhered from the atmosphere when the amorphous carbon film is in the atmosphere.

Next, each of the meshes of Example 12 and Comparative Example 4 was attached to an iron casting frame with a size of 450 mm by 450 mm via a polyester mesh. Next, each of the meshes of Example 12 and Comparative Example 4 attached to the frames was coated with an emulsion to a thickness of about 5 μm. The emulsion used was composed mainly of 13% vinyl acetate-based emulsion, 8% polyvinyl alcohol, 14% photopolymerization resin, and 65% water. A piece was cut off with a cutter knife from each of the meshes of Example 12 and Comparative Example 4 entirely coated with the emulsion, and the cut mesh pieces from Example 12 and Comparative Example 4 were subjected to a tensile test under the following conditions.

Tensile Test Conditions

Testing machine: Instron 5865

Grip length: 60 mm

Strip width: 10 mm

Measurement of elongation percentage: a video camera extensometer measures the elongation percentage between reference points marked in the samples.

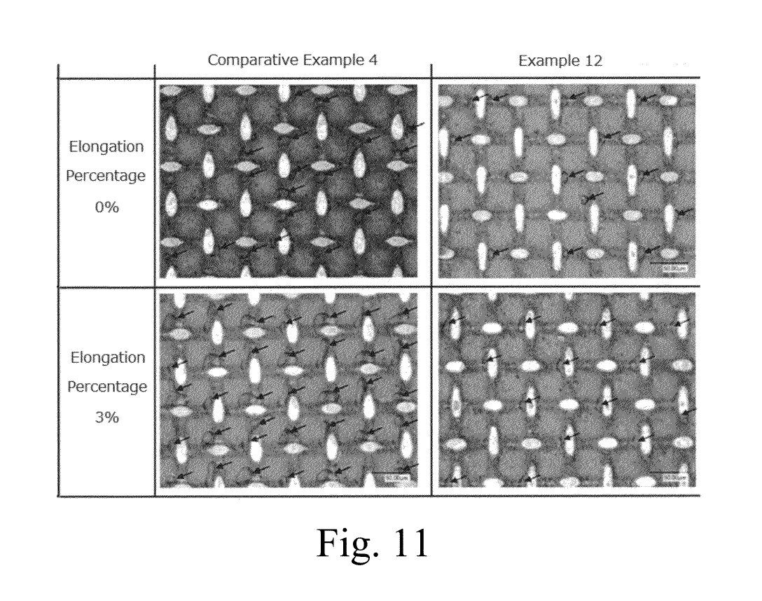

In the tensile test, the mesh pieces from Example 1 and Comparative Example 4 cut off as described above were clamped at the opposite ends and stretched; and the void count in the emulsion applied to the meshes was observed, both before and after the elongation (with an elongation percentage of 3%), under a CCD camera with a magnification of 1,000 within the same scope. As the void count is larger, the larger part of the emulsion is removed from the mesh. FIG. 11 shows comparative photographs taken by a CCD camera as described above. The photographs of the surface of the samples for Comparative Example 4 and Example 12 in FIG. 11 were taken, before and after the elongation, by a CCD camera with a magnification of 1,000. The photographs in FIG. 11 show voids produced when the emulsion is partially removed from the mesh. Voids are indicated by arrows in FIG. 11.

Table 1 shows the void counts for each of Example 12 and Comparative Example 4 based on the photographs of FIG. 11.

TABLE 1
The Number of Traces Suggesting Removal of Emulsion

| | Comparative | |
|---|---|---|
| | Example 4 | Example 12 |
| Elongation Percentage 0% | 18 | 13 |
| Elongation Percentage 3% | 35 | 14 |

As shown in Table 1, the void count in Example 12 is smaller than that in Comparative Example 4 even before the elongation. The void count in Example 12 after the elongation is much smaller than that observed in Comparative Example 4. Thus, it was confirmed that the fixity of the emulsion to the mesh is better in Example 12 than in Comparative Example 4.

As described above, it was confirmed from the measurement result of the contact angles between the samples for Examples 1 to 9 and the mineral spirit or water that a fluorine-containing silane coupling agent can be applied to a screen printing mesh according to an embodiment of the present disclosure with an excellent fixity. Also, it was confirmed from the observation result of the surface of the sample for Example 10 by a CCD camera that no opening is blocked in a screen printing mesh according to an embodiment of the present disclosure. Further, it was confirmed from the observation result of voids in the sample for Example 12 that the screen printing mesh according to an embodiment of the present disclosure can retain an emulsion with an excellent fixity.

### LIST OF REFERENCE NUMBERS

10: screen printing plate
12: frame
14: emulsion
16: mesh
18: printing pattern opening
30: electronic component conveyor
32: adsorbing collet
34: porous sheet 34

1. A primer composition comprising an amorphous carbon material containing at least one element of silicon, oxygen, and nitrogen.

2. A structure comprising a substrate and an amorphous carbon film layer formed directly or indirectly on the substrate and containing at least one element of silicon, oxygen, and nitrogen.

3. The structure of claim 2 wherein the amorphous carbon film layer is subjected to a plasma process with any one of nitrogen, oxygen, and a mixture of nitrogen and oxygen.

4. The structure of claim 2 wherein the substrate is a mesh body used for a stencil printing plate.

5. The structure of claim 4 wherein the substrate is a mesh body used for screen printing.

6. The structure of claim 2 wherein the substrate is a porous sheet body.

7. A stencil printing plate comprising: a printing mesh body; an amorphous carbon film layer formed directly or indirectly on the printing mesh body and containing at least one element of silicon, oxygen, and nitrogen; and a water repellent layer or a water- and oil-repellent layer formed on the amorphous carbon film layer.

8. The stencil printing plate of claim 7 wherein the water repellent layer or the water- and oil-repellent layer is a thin film comprising a fluorine-containing coupling agent.

9. The stencil printing plate of claim 7 wherein the water repellent layer or the water- and oil-repellent layer is a thin film comprising a fluorine-containing silane coupling agent.

10. The stencil printing plate of claim 7 wherein the water repellent later or the water- and oil-repellent layer comprises: a first layer formed on the amorphous carbon film layer and composed mainly of a coupling agent capable of forming, with the amorphous carbon film layer, a hydrogen bonding and/or an —O-M bonding (M is any one element selected from a group consisting of Si, Ti, Al, and Zr) by condensation reaction; and a second layer formed on the first layer and composed mainly of a water repellent material or a water- and oil-repellent material.

11. The stencil printing plate of claim 10 wherein the coupling agent is a coupling agent selected from a group consisting of silane coupling agent, titanate-based coupling agent, aluminate-based coupling agent, and zirconate-based coupling agent.

12. The stencil printing plate of claim 7 further comprising an emulsion layer formed on the printing mesh body, wherein the amorphous carbon film layer is formed on the emulsion layer.

13. (canceled)

14. (canceled)
